(19) United States
(12) Patent Application Publication
(10) Pub. No.: US 2007/0221510 A1
(43) Pub. Date: Sep. 27, 2007

(54) Field portable electrochemical sensor for uranium and other actinides

(76) Inventors: Dale D. Russell, Boise, ID (US); William B. Knowlton, Boise, ID (US)

Correspondence Address: PEDERSEN & COMPANY, PLLC, P.O. BOX 2666, BOISE, ID, 83701, US

(21) Appl. No.: 11/600,663

(22) Filed: Nov. 15, 2006

Related U.S. Application Data
(60) Provisional application No. 60/737,465, filed on Nov. 15, 2005.

(51) Int. Cl. G01F 1/64

(52) U.S. Cl. 205/789.5

(57) ABSTRACT

An actinyl-selective polymer detects the presence of actinide ions in a solution. An electrode or FET gate surface of a sensor element may be coated or otherwise made to include the actinyl-selective polymer, which preferably includes chelating molecules selective to ions having the general formula MO₂^{X}, where M represents any metal in the actinide group and X represents 1+, 2+, or any other charge state, including uranium ions (UO₂²⁺), plutonium ions (PuO₂²⁺, PuO₂¹⁺), and thorium ions (ThO₂¹⁺) and others. The chelating polymer is preferably made by first polymerizing a selected monomer and then derivatizing the polymer with a calix[n]arene rings (where n=4-10) compound, resulting in a high density of chelating molecules on the surface of the polymer, where they are accessible to the solutions being testing and cleansing or rejuvenating solutions.

This application claims priority of U.S. Provisional Application Ser. No. 60/737,465 filed Nov. 15, 2005, and entitled “Field Portable Electrochemical Sensor For Uranium and Other Actinides,” which is hereby incorporated by reference.

### BACKGROUND OF THE INVENTION

1. Field of the Invention

This invention relates generally to an electrochemical sensor and methods for detecting uranium, plutonium, and other transuranic elements as their water-soluble ions. The invented sensor is selective for uranium ions (UO₂²⁺), plutonium ions (PuO₂²⁺, PuO₂¹⁺), and thorium ions (ThO₂¹⁺) and other chemical species having the general form MO₂^{X} (typically, MO₂²⁺ or MO₂¹⁺), where M represents any metal in the actinide group and X represents 1+, 2+, or any other charge state.

### RELATED ART

There is considerable interest in developing a rugged, portable, battery-powered sensor that detects transuranic elements such as uranium and plutonium, especially when dissolved in or shielded by water. There is a critical need for new ways of detecting these radionuclides, including their detection in waste streams, holding tanks, surface and ground waters, and in all kinds of shipping containers. In addition, there is need for sensor devices that can be deployed clandestinely and used secretly, for example, for nuclear non-proliferation treaty verification in hostile or non-cooperative countries.

Prior methods of detecting uranium and plutonium generally are laboratory-based methods requiring large-scale instrumentation and high-voltage power supplies. These prior methods are typically embodied in devices that are not portable. Further, many of these methods detect the radiochemical signals of nuclear materials, but do not detect alpha-emitters such as uranium and plutonium that are dissolved or immersed in water, or are otherwise shielded within a container. As many methods of shipping radioactive materials involve immersion/dissolving in water, devices that rely on the radiochemical signals fail to detect such dissolved or shielded nuclear material, making them unsuitable for container screening.

Ippolitti, et al. (U.S. Pat. No. 5,646,296) discloses the use of a chelating agent, based on polymers made from bis-imidazolyl compounds, for the removal of actinides, particularly plutonium (specifically, Pu⁴⁺), from solution. However, in this reference, no method of selectively identifying or quantifying actinide ions is disclosed.

Wang, et al. (U.S. Pat. Nos. 5,676,820 and 5,942,103) discloses an anodic-stripping voltammetric instrument that uses the electrochemical signature of uranium for sensing its presence. The disclosed instrument is a complex device, is not small in size, requires housing for a number of solutions in reservoirs, and must be supplied with power by cable. Although the Wang device is capable of detecting uranium and chromium, there is no indication that it is capable of detecting plutonium or any other actinide species except uranium.

Port, et al. (U.S. Pat. No. 6,372,872) discloses formation of a rigid polymer that is selective for a chosen dissolved species. The monomer is complexed with a chosen ion prior to polymerization. After polymerization the ion is removed and the remaining polymer processed and coated on a substrate. Because the polymeric structure is rigid, the removal of the complexed ion leaves receptor sites that are selective for that ion. The polymer may be coated onto an electrode or similar device for use in a detector, but no detector that detects multiple ions of one element or multiple ions of different elements is disclosed.

Russell (U.S. Pat. No. 6,436,259) discloses a device for detecting the presence of mercury. The device includes an electrode that selectively forms covalent bonds with mercury and can quantify the presence of mercury thereon by measuring the change in the electrode's conductive properties from the presence of mercury.

There is still a need for a practical and useful way of sensing the presence and measuring the amount of water-soluble materials comprising metals from the actinide group. Embodiments of the invention meet this need, providing apparatus and methods for sensing uranium, plutonium and other transuranic soluble ions, for example, for alerting the proper authorities for safety precautions and accident prevention. The preferred apparatus should be portable and self-contained (preferably without solutions or reservoirs therefore other than optionally a reservoir/container for the fluid being tested for actinide group metals). The preferred apparatus should be capable of autonomous operation for long-term in situ monitoring of potentially contaminated sites.

### SUMMARY OF THE INVENTION

The present invention comprises a sensing element that preferentially captures actinide ions for detecting and quantifying the presence of such ions in a solution. The sensing element comprises a polymer to which chelating molecules are bound, the polymer with chelating molecules being highly selective for actinide ions over other metal ions, greatly reducing the probability of false-positive readings. Captured actinide ions alter the conducting properties and surface potential of the sensing element(s). Current arising from electron transfer at the actinide ion, due to oxidation or reduction of the trapped actinide ion, may be measured because the polymer is conductive. Changes in electron transfer at the actinide ions and/or changes in surface potential of the chelating polymer may be measured using conventional circuit elements, such as operational amplifiers and analog-to-digital converters in order to derive the concentration of actinide ions.

Embodiments of sensing elements may be designed to detect the total concentration of actinide ions and/or the individual concentrations of specific ions of the actinide group. In the preferred embodiments, multiple sensing elements embodying differing detection methods and circuitry are used in order to measure a) total actinide concentration, b) the concentration of individual actinide species, and c) to crosscheck the accuracy of individual sensors.

The preferred multiple sensor elements comprise a voltammetric element, which detects changes in electrical current, and a Field Effect Transistor (FET) element, which responds to changes in surface potential. The invented sensor element(s) and cooperating circuitry may be housed in a compact probe casing, and may cooperate with a battery or other portable power source, a microcontroller, and a data recording buffer and/or data transmission system, in order to provide a compact, portable detection unit.

### BRIEF DESCRIPTION OF THE DRAWINGS

FIG. 1 is a schematic representation of steps for covalently bonding one embodiment of a chelating molecule to a monomer for one embodiment of a sensing element of the present invention.

FIG. 2 is a schematic representation of one embodiment of a polymer comprising a chelating monomer similar to that in FIG. 1, wherein the resulting polythiophene polymer, with derivatized units attached to the polymer backbone, is coated onto an electrode surface and wherein a uranyl ion (UO₂²⁺), is captured in the chelating ring.

FIG. 3 is a schematic representation of steps for synthesizing an alternative embodiment of chelating polymer, according to another embodiment of the invention, using poly(cyclopentadithiophene) (“poly(CPDT)”), with a derivatizable functional group on the cyclopentane ring, and polymerization prior to attachment of the chelating molecule.

FIG. 4 is a schematic representation of one embodiment of a polymer comprising a chelating monomer and polymer backbone of FIG. 3, wherein the polymer is coated onto an electrode surface, prior to attachment of the chelating molecule, and wherein a uranyl ion (UO₂²⁺), is captured in the chelating ring pictured to the right.

FIGS. 5 and 6 are schematic representations of steps for synthesizing an alternative embodiment of chelating polymer, according to another embodiment of the invention, using a Wittig-Horner scheme (with a “Wittig reagent”), which results in a double bond in conjugation with the poly(CPDT) chain.

FIG. 7 portrays one embodiment of the invented probe, comprising a three-electrode voltammetric sensor element comprising a chelating polymer according to one embodiment of the invention.

FIG. 8 portrays one embodiment of the invented portable, compact detection system for actinide ions in aqueous solution, utilizing the probe of FIG. 7.

FIG. 9 is a schematic illustration of an alternative embodiment of the invented probe, comprising many sensor elements, of same or different kind, according to embodiments of the invention, and a slideable cover system that exposes one or more sensor elements at a time out of the long strip of sensor elements.

FIG. 10 is a circuit diagram of one embodiment of the three-electrode voltammetric-sensor element of FIGS. 7-9.

FIG. 11 is a graph of a “voltage sweep” (current vs. volts vs. standard reference electrode), for a sensor element/electrode made according to the synthesis in FIGS. 1 and 2, exposed to a blank solution and a solution containing uranium ions.

FIG. 12 is a graph of Intensity (μAmps) vs. concentration of uranium in solution as uranium nitrate, showing the response of an electrode, made according to the synthesis in FIGS. 1 and 2, to various concentrations of uranium at a given voltage.

FIG. 13 is a graph of a voltage sweep (μAmps vs. volts), showing the response of an electrode, made according to the synthesis in FIGS. 1 and 2, to a blank solution and to a solution comprising both uranium and plutonium.

FIG. 14 is a schematic cross-sectional representation of one embodiment of an alternative sensor element according to the invention, the sensor element comprising an adapted Metal Oxide Semi-Conductor Field-Effect Transistor (MOSFET).

FIG. 15 is a schematic perspective view of the MOSFET sensing element of FIG. 14.

FIG. 16 is an IR microscopic image of an embodiment of a p-channel metal oxide semiconductor FET (pMOSFET) sensing element, such as that schematically portrayed in FIGS. 14 and 15, which has a chelating polymer layer deposited onto a 20 μM by 80 μM gate metal.

FIG. 17 is a schematic of the nL cell concept on which the FET sensing element of FIGS. 14-16 is based.

FIG. 18 is a plot of drain current vs. drain voltage for a MOSFET, at three different gate potentials, showing FET performance before deposition of the chelating polymer of the gate metal of the FET (the “unadapted FET”—the bare device), performance after deposition of the chelating polymer (the “adapted FET”) but without any uranium solution soaking, and performance of the adapted FET after soaking in a solution containing uranyl acetate for 1 hour (“adapted FET having contacted uranium”). The “adapted FET having contacted uranium” data was obtained by soaking the FET in a uranium acetate solution for 1 hour, removing and drying the FET prior to testing, thus showing a response of the FET, outside of the uranyl ion solution, resulting from the uranium remaining complexed to the polymer.

FIG. 19 is a schematic perspective view of an alternative embodiment of a probe of the present invention, utilizing one embodiment of a voltammetric-sensor element according to the invention and one embodiment of an FET-sensor element according to the invention, wherein the top cover of the probe housing is removed to reveal the sensor elements and microprocessors.

FIG. 20 is a partial, side detail view of the ports 25 of the probe of FIG. 21.

FIG. 21 is a circuit diagram of one embodiment of the invented detection system, comprising both a voltammetric-sensor element and an FET-sensor element.

FIGS. 22-24 are graphs of data from an electrode according to an embodiment of the invention that was tested in aqueous solutions containing a wide range of UO₂²⁺ concentrations.

FIG. 25 is a graph of data from an electrode according to an embodiment of the invention that was tested in aqueous solutions containing a range of ThO₂⁺ ions.

FIG. 26 is a graph of data from an electrode according to an embodiment of the invention tested in an aqueous solution containing both uranium and thorium.

### DETAILED DESCRIPTION OF PREFERRED EMBODIMENTS

Referring to the figures, there are shown several, but not the only, embodiments of the invented actinyl-selective polymer, sensor element(s), and detection system for actinide ions. The preferred detection system comprises one or more sensor elements that comprise a polymer that selectively binds/chelates with actinide ions. The actinide-selective polymer may be placed on an electrode surface of a voltammetric sensor element, and/or may be placed on a gate surface of a FET sensor element, as will be discussed below in more detail. The preferred embodiments ignore the radiochemical properties of the actinide materials, and instead deal with the solvated actinide ions as redox-active metals. Therefore, the preferred embodiments are based on electron transfer chemistry and not radiochemical properties.

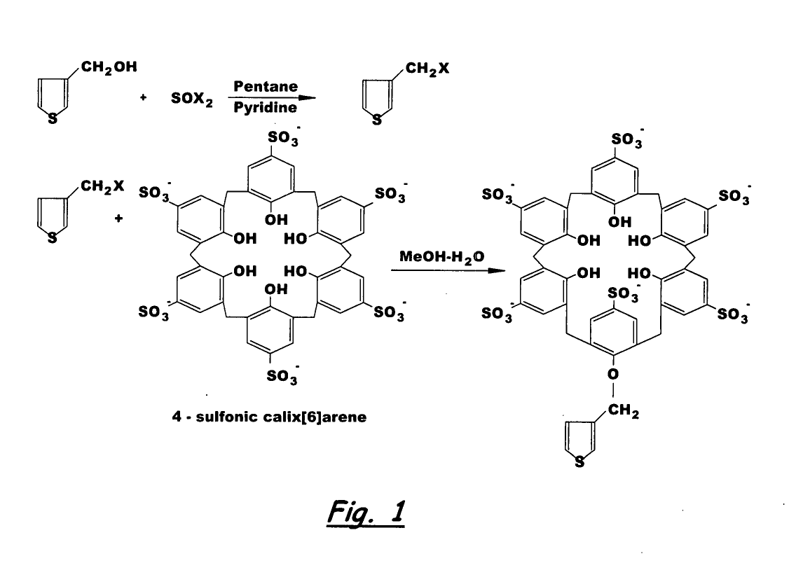

Referring to FIG. 1, there is shown one method of forming a monomer for a polymer with binding sites that are selective for actinides. In one method, a monomer is prepared by attaching a chelating ring prior to polymerization. In the preferred embodiment, 3-thiophenemethanol is reacted with thionyl chloride via a SN₂ mechanism, while in pentane and in the presence of hydrogen scavenger pyridine, to obtain 3-methylchloridethiophene. One may note that, in FIG. 1, X may be chloride or other halogen(s). One may note that 3-thiophenemethanol is the initial reactant in this first step and not thiophene, and the inventor typically purchases 3-thiophenemethanol from a source such as Aldrich Chemicals and use it as is, with no distillation or drying. If thiophene is used, rather than 3-thiophenemethanol, attachment of the chelating molecule may occur in the 2-position on the thiophene, which has the negative result of being polymer-chain-terminating. By using 3-thiophenemethanol, on the other hand, places the chelating molecule only in the 3-position, which is not polymer-chain terminating.

To continue from the last step described above, the 3-methylchloridethiophene is then reacted very slowly with 4-sulfonic calix[6]arene (C6A) via a SN₂ mechanism, forming an ether bond between the chelating structure and the thiophene monomer, and thus derivatizing the monomers. At least one form of calix[6]arene (C6A) is commercially available from AlfaAesar. The derivatized monomers are then mixed with underivatized thiophene, usually in the form of bithiophene, in a plating solution. Acetonitrile, dichloromethane, nitromethane, or any other plating solution solvent may be used that supports concentrations of the monomers in an appropriate range (preferably concentrations ranging from 0.001 mol/L to 0.1 mol/L). The plating solution is then subjected to electrochemical deposition conditions, wherein a current is applied to the electrode in the solution. This causes the monomers to polymerize at or on the surface of the electrode, precipitating out of solution and bonding with the electrode surface.

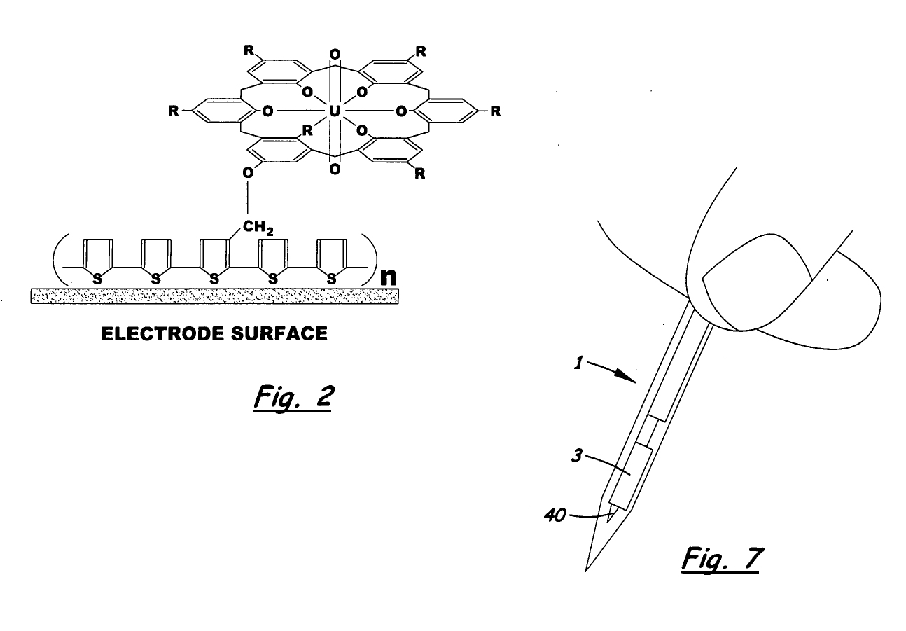

FIG. 2 is a schematic representation of one embodiment of the resulting electrode/sensing surface of the present invention binding/chelating a uranyl ion, wherein the uranyl ion may be seen generally centered in the chelating ring, and the chelating ring is shown with R generalized (rather than SO₃⁻), wherein R may be hydrogen or any hydrocarbon functional group or any heteroatom containing functional group(s). R is preferably selected for its contribution to solubility, as it plays little or no role in the actinide chelating function. SO₃⁻ is preferred, as it provides good solubility in water, but is not necessarily required.

It should be noted that embodiments of the invented chelating polymer may be plated or otherwise incorporated into various shapes and configurations of electrodes, including a microarray electrode design. In such a microarray design, many small, spaced, electrode portions comprising the chelating polymer(s) may be provided in an electrode unit, so that mass transfer to the electrode portions is not limited.

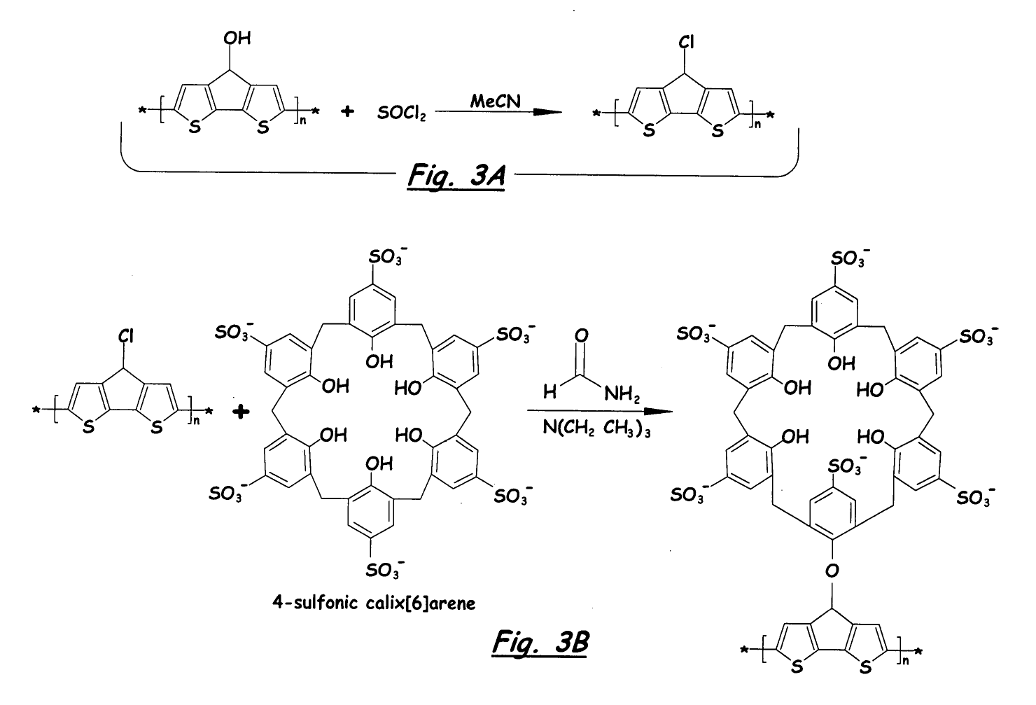

Attachment of Chelating Rings after Polymerization (See FIGS. 3A and 3B):

Alternatively, derivatization with the chelating molecule may be done after polymerization of monomers, rather than before. That is, monomer may be polymerized, and then the chelating molecule, such as 4-sulfonic calix[6]arene (C6A) or other chelating molecule(s), may be added to the polymer, for example, by the technique described below.

1. Deposit a thin layer of poly(bithiophene) on the prepared metal substrate under the following conditions:
a. Bithiophene is dissolved in an appropriate polymerization solvent at concentrations between 0.001 M-0.1 M, with 0.01 M-0.05 being preferred. Acetonitrile, nitromethane, dichloromethane, nitrobenzene and ethanol, for example, are solvent options, with acetonitrile or nitromethane preferred.
b. Temperature is maintained at or below 10° C., down to about −5° C., depending on the freezing point of solution. Lower temperature is generally better.
c. Any of several electrochemical deposition modes can be employed, including but not limited to:
   (i) a potential set-and-hold method, to deposit polymer at 1.0 v (±0.5 v) vs. silver/silver chloride reference electrode;
   (ii) a cyclic voltammetric method wherein the potential of the electrode to be coated is swept from about 0.5 v to about 1.1 v, vs. a Ag/AgCl reference electrode; or
   (iii) a controlled current method, where a constant anodic current is imposed at the electrode to be coated.

The resulting thin layer may be considered a “pre-coat” layer, which covers well at a relatively low potential, but is not readily derivatized.

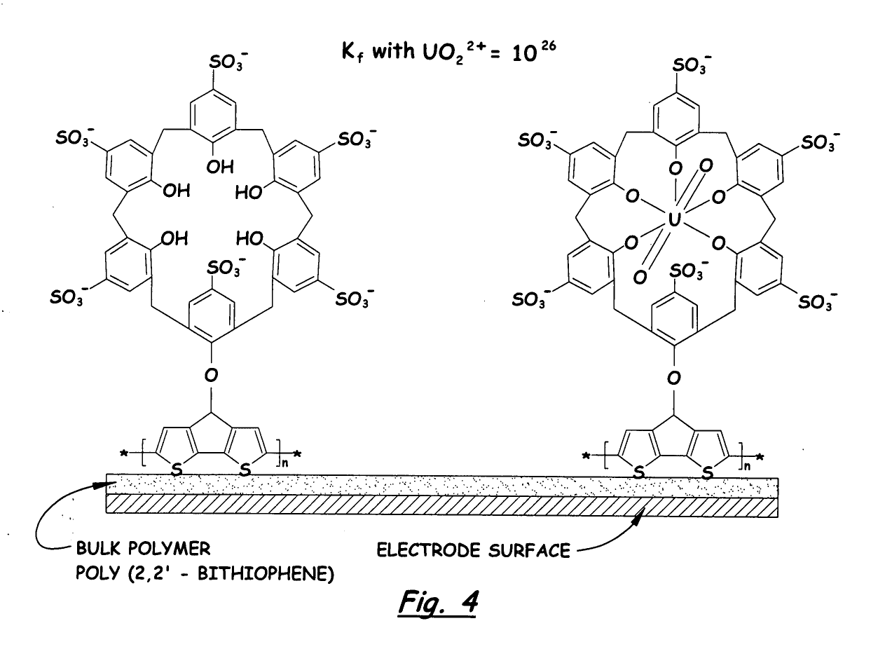

2. Deposit a second polymer layer. This layer tends to deposit readily over the poly(bithiophene) layer described in No. 1, above, and may be derivatized to include chelating rings.
a. This second layer, which is coated over the first, poly(bithiophene) layer, is poly(cyclopentadithiophene) (“poly(CPDT)”), with a derivatizable functional group on the cyclopentane ring. See FIGS. 3 and 4.
b. Polymer conditions such as recited above in No. 1 may be used. Alternatively, the temperature may be increased, and/or other concentrations and/or solvents may be used.

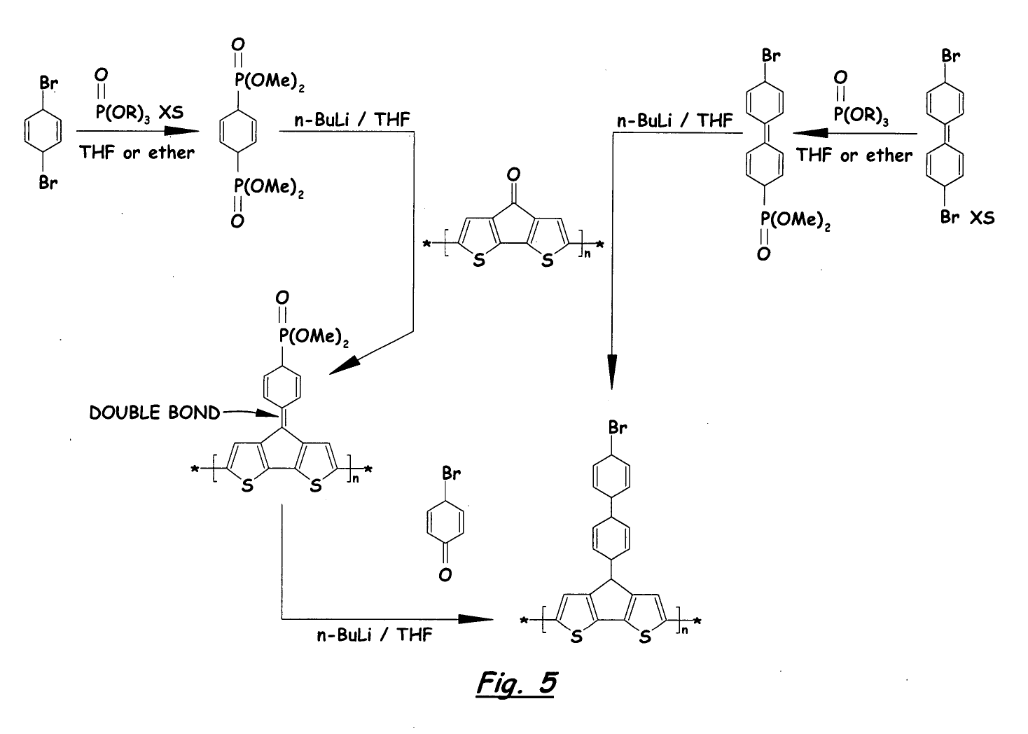

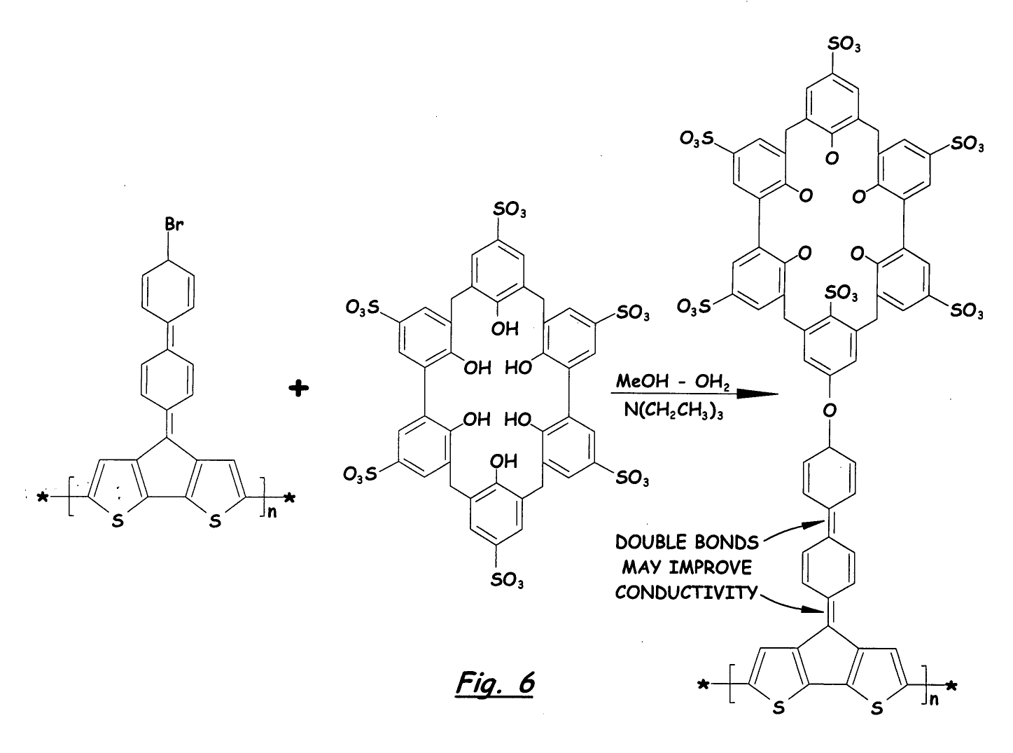

3. Attach the chelating ring.
a. The functional group on the cyclopentane ring is derivatized using any reaction scheme that will attach the desired chelating ring. The same reaction scheme may be used as was used in derivatizing the monomer prior to polymerization. See FIGS. 3 and 4.
b. Alternatively, a preferred type of reaction results in a double bond in conjugation with the poly(CPDT) chain. One such a double-bond method is to use a Wittig-Horner scheme (using a “Wittig reagent”), as illustrated in FIGS. 5 and 6. The double bond conjugation is believed to improve conductivity of the polymer, and, therefore, the sensitivity of the probe, which will lower the detection limit of the probe.

The method of derivatizing monomer with chelating molecules and then polymerizing results in a polymer with chelating molecules spaced throughout the polymer, in positions determined at least in part by the relative concentrations of derivatized monomer and non-derivatized monomer in the plating solution. This method (of attaching the chelating molecules and then polymerizing) promotes chelating molecules being “buried” inside the polymer, and promotes individual (single) chelating molecules being attached at multiple sites on the polymer, both of which results tend to make the chelating rings less accessible to analytes in the solutions being tested, and less accessible to cleaning solutions and methods.

On the other hand, the method of polymerizing monomer followed by derivatizing with the chelating rings, such as illustrated above in Sections 1-3, would produce close packing of chelating rings on the polymer, wherein the “packing density” is limited only by steric hindrance. In such methods (polymerizing prior to attachment of chelating rings), the chelating rings tend to attach only onto the surface of the pre-made polymer, rather than be buried inside the polymer and rather than a single chelating ring being bound to multiple chains/backbones of the polymer. This way, the chelating rings are attached in a more controllable manner at locations that are inherently accessible to solutions, and therefore, accessible to solutions being tested and/or to cleaning solutions. Only solution-accessible sites are derivatized with the chelating rings, so that the chelating rings and the actinyl ions captured are not retained deep within the bulk polymer. The bulk polymer is not disrupted by chelating ring sites, so that the bulk polymer may retain its mechanical and electrical properties.

Cyclic calix[6]arene has been shown to be effective in embodiments of the invention, but other chelating molecules are envisioned, such as a linear calix molecule or other chelating chains or rings. For example, calix[n]arenes where n=4-10 are expected to be effective. The larger rings, such as n=7-10, may have advantages in that they may form sensor elements that chelate actinyl ions effectively but that also release the ions easily enough to make cleaning/regenerating of the sensor convenient.

Also, while non-covalent attachment of chelating molecules is also envisioned, covalent attachment of the chelating molecule is preferred in order to produce a rugged and long-lived polymer (expected to last on the order of two years). Also, while various monomers/polymers are envisioned as being effective, thiophene or bithiophene monomers and polythiophene or poly(bithiophene) polymers, or derivatized variations of these monomers/polymers, are preferred because of their relatively non-toxic and non-hazardous characteristics and the robust, high-integrity films they form. Derivatization of these preferred monomers/polymers may include, for example, any functional group that improves polymer deposition and/or electrical or mechanical properties of the bulk polymer, without interfering with chelating molecule attachment. Further, while electro-deposition of the polymer on the electrode or gate is preferred, it is envisioned that other methods of attachment to the electrode or gate surface may be used, for example, dip-coating, vapor deposition, spin coating or others.

The binding site resulting from the above methods is a chelating molecule of a size, geometry, and electrostatic arrangement that selectively binds/coordinates with actinide ions, even in the presence of much greater quantities of various other metals. Actinide ions are known to be chemical species having the general formula MO₂^{X+} (where M represents any metal in the actinide group, and X may be 1 or 2, or any other oxidation state, such as UO₂²⁺, PuO₂²⁺, PuO₂¹⁺ (a common species of plutonium in neutral pH waters), ThO₂²⁺, ThO₂¹⁺ and others.

In embodiments using 4-sulfonic calix[6]arene (C6A), the selectivity ratios range from 10¹² to 10¹⁷ and higher, in the presence of much larger amounts of other non-actinide metals. This high degree of selectivity, resulting from an exceptionally high formation constant of binding between actinides and the chelating ring, minimizes the potential for false-positive responses.

The binding reaction for uranium ion with 4-sulfonic calix[6]arene (C6A) may be described as: UO₂²⁺+H₅ ring→5H⁺+[UO₂-ring]³⁻, wherein the net surface charge change is −3e per occupied site (where e is the charge on e⁻).

In use, the sensor element surface comprising the chelating polymer is brought into the presence of aqueous phase samples or bulk quantities, which may possibly contain actinide ions. As discussed above, actinide ions that are present in solution are selectively captured by (bound by chelation to) the chelating rings on the polymer. The presence of actinide ions in the chelating rings, in-turn, alters the conducting properties of the sensor element due to electron transfer at the captured actinide ions, and alters the electrical potential of the sensor element surface. These effects may be detected, and, hence, the presence of actinides may be detected and quantified, by a voltammetric-based system (in which the chelating polymer is preferably deposited on one electrode/contact of a multiple electrode/contact system) and/or by a FET-based system (in which the chelating polymer is preferably deposited on the FET gate).

In embodiments of the invention utilizing a voltammetric-sensor element in a potentiostat circuit, a linear sweep pattern, or other potential (voltage) sweep patterns, such as linear plus square wave or AC plus sine wave, may be applied between the polymer-coated electrode and the reference electrode. In the presence of actinide ions, electron transfer will occur across the solution/electrode interface of the polymer-coated electrode at the specific potential that is characteristic for any given actinide ion that is present in the solution. The magnitude of current corresponds to the total amount of that actinide bound on the surface of the polymer-coated electrode, which is a function of actinide concentration in the solution. In other words, because each metal has its own characteristic reduction potential, differentiation of various actinide ions from each other may be done by scanning a range of potentials and noting where electron transfer occurs (evidenced by a peak in current). The potentials at which this electron transfer occurs and the amount of current at each reduction potential reveal the “redox signature,” which yields information on the species and amount of each actinide present.

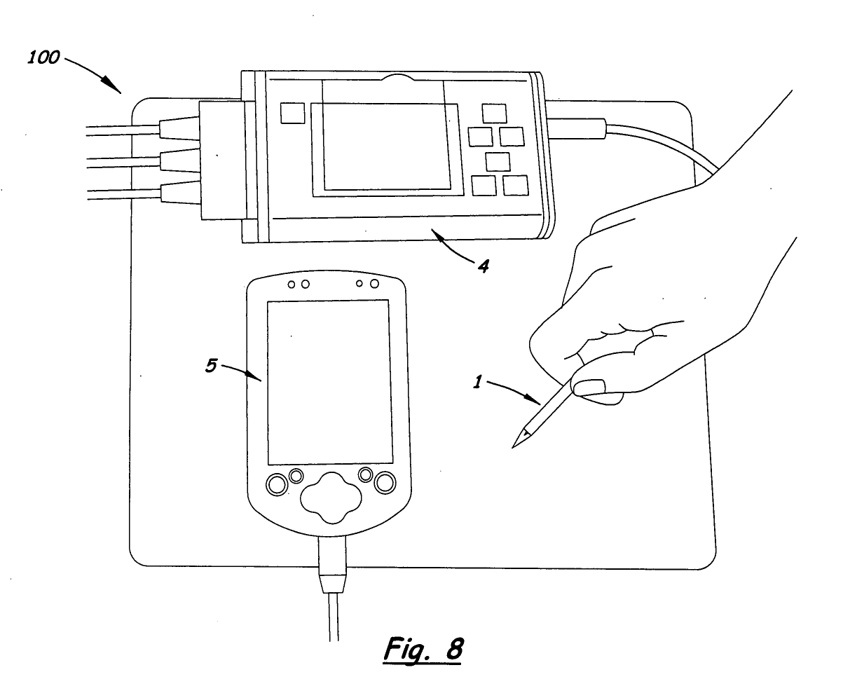

FIG. 7 illustrates one embodiment of the invented probe 1 comprising a voltammetric-sensor element 40 comprising a chelating polymer, such as that portrayed in FIG. 2, which selectively binds with actinide ions via the 4-sulfonic calix[6]arene (C6A) chelating ring. The probe 1 in FIG. 7 includes a sliding window cover 2 that reveals the sensor element 40. The invented probe 1 may be part of a detection system 100, as shown in FIG. 8. In this system 100, probe 1 communicates and cooperates with a commercially-available potentiostat system, such as a PalmSens™ Electrochemical Sensor Interface 4, and a hand-held or other portable computer 5 which contains correlations between the current-voltage response and the actinide ion concentration, said correlations being derived from empirical data such as the testing and calibrations shown in the Worked Examples later in this Description. As may be seen from FIG. 8, the preferred detection system 100 may be small, portable, preferably hand-held, and battery powered. As the preferred systems require approximately 5 volts or less, a battery is sufficient for long-term use, and the preferred system does not require connection to any power grid during normal operation. The preferred system does not have moving parts. The preferred system does not require liquid reagents or other liquid chemicals, or reservoirs for storing such liquid materials. Alternatively, if rejuvenation of the probe is needed for reuse, a set of cleaning solutions, including, for example, strong mineral acid, may be supplied, as the chelation in some embodiments is believed to be reversible or at least quasi-reversible because of the stability of the coordination sphere. Strong mineral acid is believed to protonate the donor atoms in the coordination sphere of the chelating molecule, thus promoting dissociation of the actinide ion from the chelating complex.

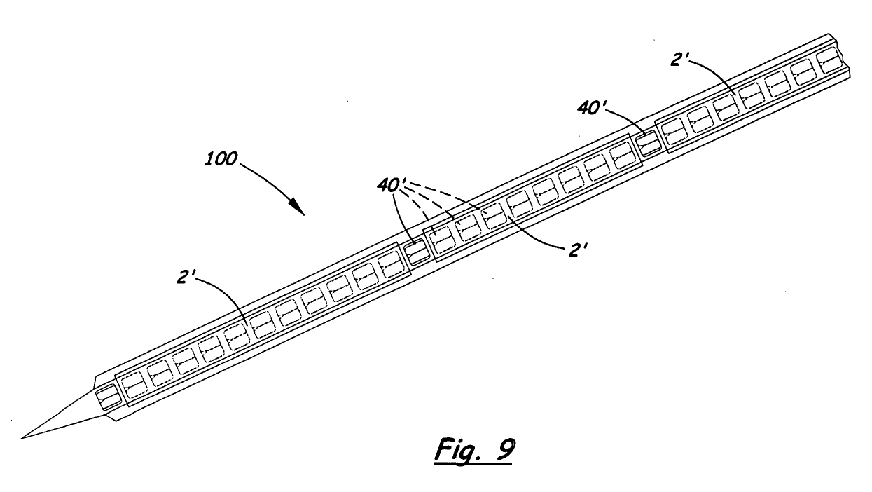

In embodiments wherein the chelating polymer cannot be adequately cleaned for multiple uses, multiple polymer surfaces may be supplied in a single probe, such as schematically represented in FIG. 9. Probe 100′ may include a strip 40′ of many sensor elements or polymer surfaces, which may be exposed, one at a time or in combinations, by a system of slideable or otherwise moveable covers 2′. This way, a single probe may be used many times even if the polymer surfaces are not capable of being cleaned or rejuvenated.

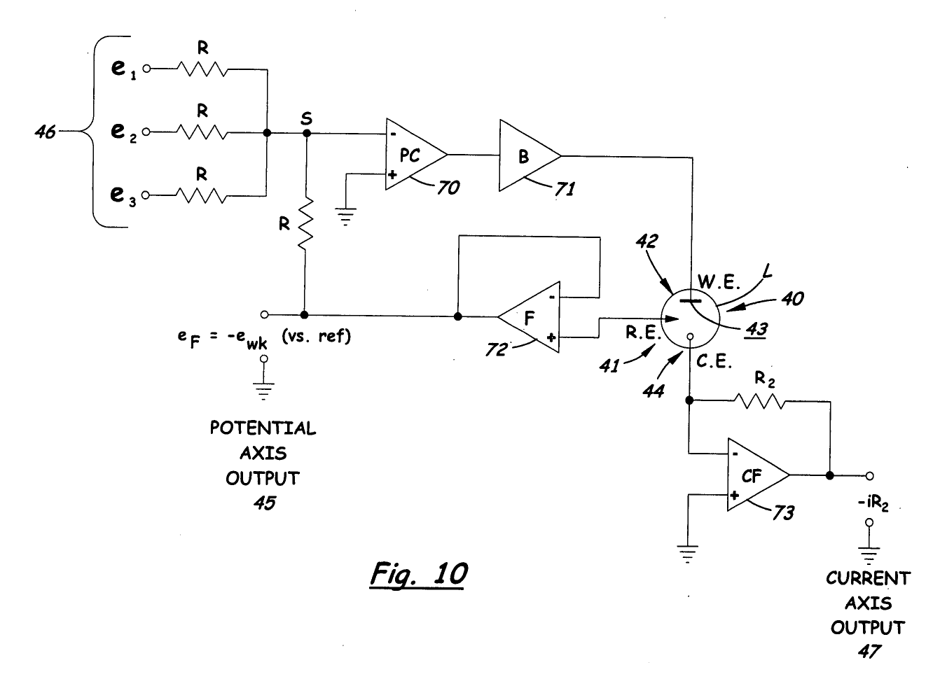

A schematic circuit diagram in FIG. 10 illustrates one embodiment of a voltammetric-sensor circuit, which is a three-electrode system that may be embodied as a three-contact integrated circuit device on a wafer. This preferred voltammetric-sensing circuit is constructed using a three-contact sensor device 40 accompanied by drive and measurement amplifiers 70 through 73. Sensor 40 and surrounding circuitry can be constructed together using conventional semiconductor device fabrication means, as an integrated circuit upon a silicon substrate. The three electrode contacts in sensor 40 are: a) a silver Reference Electrode (RE) 41; b) Working Electrode (WE) 42 with actinyl-selective-polymer-coated surface 43; and c) a Counter Electrode, (CE) 44, which is platinum or palladium or any integrated-circuit-compatible conductive material. Surrounding the three sensor elements, RE, WE, and CE, in FIG. 10, is a liquid sample L such as a volume of water contacting each of the three electrodes. These electrodes are typically spaced from 20 to 200 microns apart but may be much farther if desired. Electrode (RE) 41 is input to a high impedance operational amplifier 72, having an input current drain of typically less than 1 nanoampere. In other words, only a very small current (sub-nanoamp) is drawn through the reference electrode 41. As a high input impedance electrode, electrode 41 is suitable as a voltage measurement point, and it provides potential-axis output signal 45.

Amplifier B (71) provides low impedance output drive proportional to the voltage present at summing node S, which is the sum of the three voltage inputs 46. Typically these inputs 46 are connected to sweep voltage generators and DC offset voltage sources to provide suitable excitation for sensor 40. Electrode CE is introduced to current follower amplifier CF (73), that in turn presents a voltage level output, proportional to the current level at electrode 41, as current-axis output signal 47.

Voltammetric sensor 40, unlike the FET-based actinide sensor described below, has the capability to distinguish between different actinide ions, since each actinide has a particular characteristic reduction potential. Different actinides are detected separately by scanning a range of potentials with a voltage sweep generator and noting where electron transfer occurs. For example, UO₂²⁺ is reduced to UO₂⁺ at 0.163 V vs. standard hydrogen electrode (SHE), while PuO₂²⁺ is reduced to PuO₂⁺ at 1.013 V vs. SHE, a difference of nearly a volt, which is far more than is necessary to differentiate these ions in the preferred systems. Measuring the amount of current at each reduction potential, in view of appropriate calibration standards, will yield information on the amount of each actinide species present.

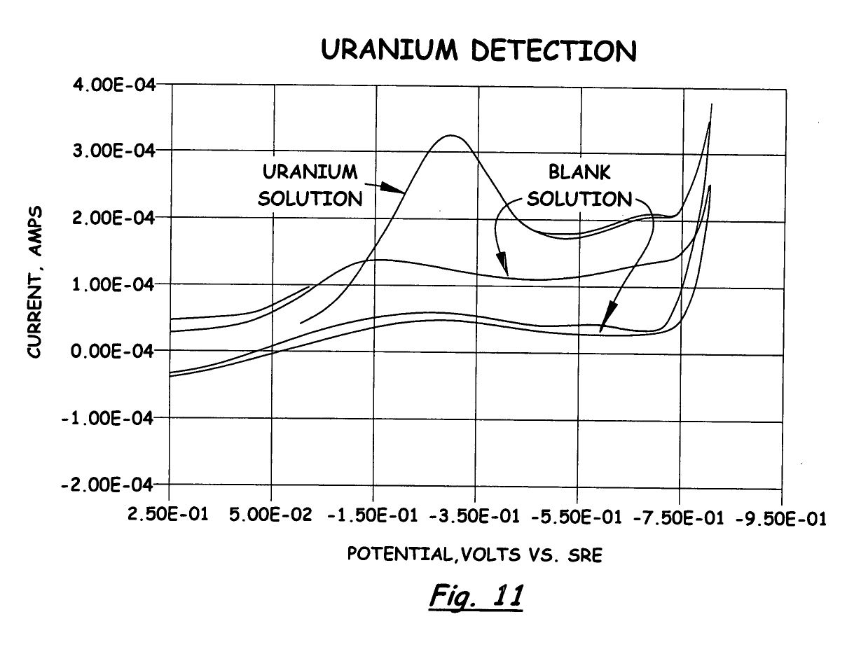

FIG. 11 provides an example of data from a chelating-polymer-coated electrode, made by the methods illustrated by FIGS. 1 and 2 according to one embodiment of the invention, wherein the electrode was connected to a potentiostat (voltage sweep generator) and tested by “sweeping cycles” of voltage between approximately 2.50 E-01 to −9.50 E-01 volts vs. the standard reference electrode, resulting in what may be called a cyclic voltammogram. This was done both for a blank solution of pure H2O to establish “background,” and with a uranium solution (uranyl ions (UO₂²⁺)). As may be seen from FIG. 11, the shape of the current vs. potential curves shows significantly increased current for the uranium solution, compared to pure H2O, over the range of about −1.5 E-01 to −7.5 E-01, and particular at approximately −3 E-01 vs. Ag/AgCl electrode.

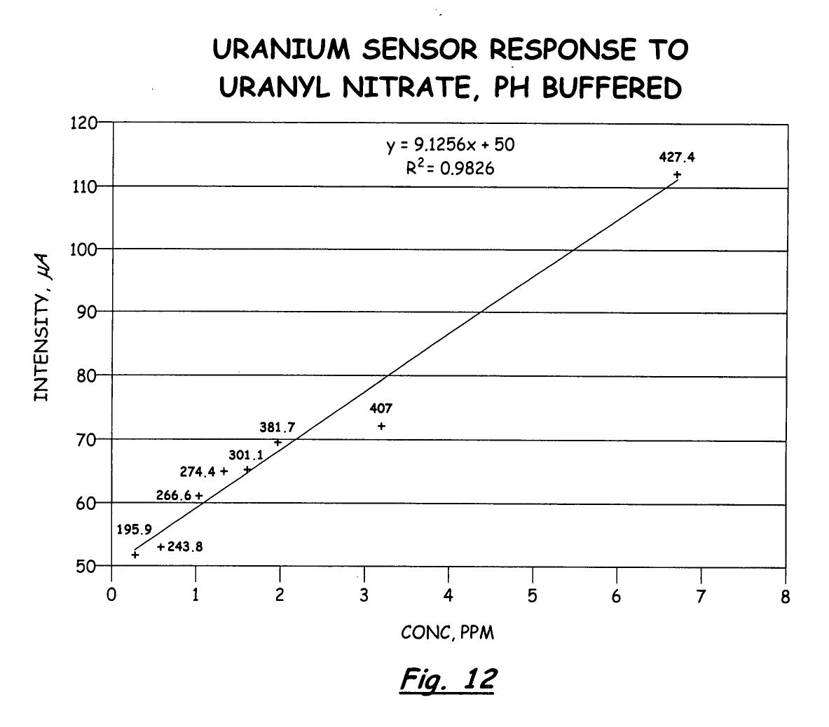

FIG. 12 further illustrates the response of a chelating-polymer-coated electrode, made by the methods illustrated by FIGS. 1 and 2 according to one embodiment of the invention, wherein the electrode was exposed to different concentrations of uranyl ions (UO₂²⁺ with nitrate as counter-ion). As may be seen in this FIG. 12 “calibration curve”, a linear relationship between increasing microamps and increasing ppm concentration of uranium was found, following the equation y=9.1256×+50, with an R²=0.9826.

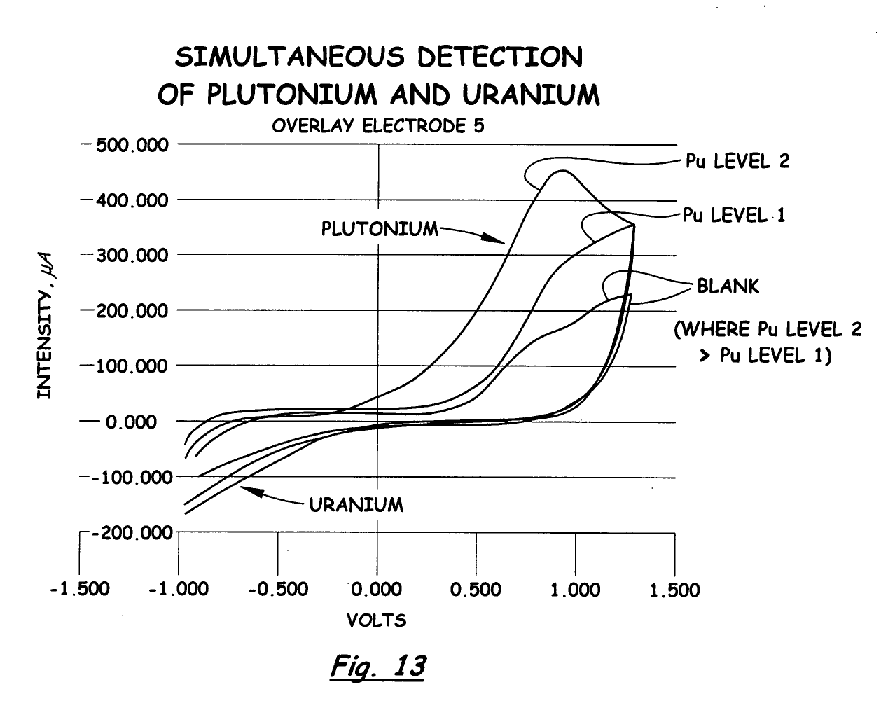

FIG. 13 is a voltage sweep (μAmps vs. volts), showing the response of a chelating-polymer-coated electrode to a blank solution and to two solution comprising both uranium and plutonium ions (a low concentration of plutonium ions (concentration x) and a high concentration of plutonium ions (about twice, or 2×), with a smaller concentration (about 0.1×) of uranium in both solutions. The electrode was made according to the synthesis in FIGS. 1 and 2, wherein an aluminum foil electrode was coated with a co-polymer of thiophene and calix[6]arene-derivatized thiophene under the following conditions: cyclic voltammetric deposition mode, 0.01 M thiophene and 0.004 M calix[6]arene-derivatized thiophene in acetonitrile. The electrode exhibits significantly different responses to the three solutions, providing data that may be used to detect multiple ions in the same solution at generally the same time. The inventors believe the response to uranium is visible in the 0 to −1.0 volt region, and the response to plutonium is visible in the 0 to +1.25 volt region of the sweep. The inventors believe these responses are due to the reduction of UO₂²⁺ (uranium from a +6 state to a +5 state) in the 0 to −1.0 volt region, and oxidation of PuO₂¹⁺ (plutonium from a +4 state to a +5 state) in the 0 to +1.25 region. This confirms the ability of embodiments of the invention to detect water soluble uranium and water soluble plutonium ions, and to do so in the same test.

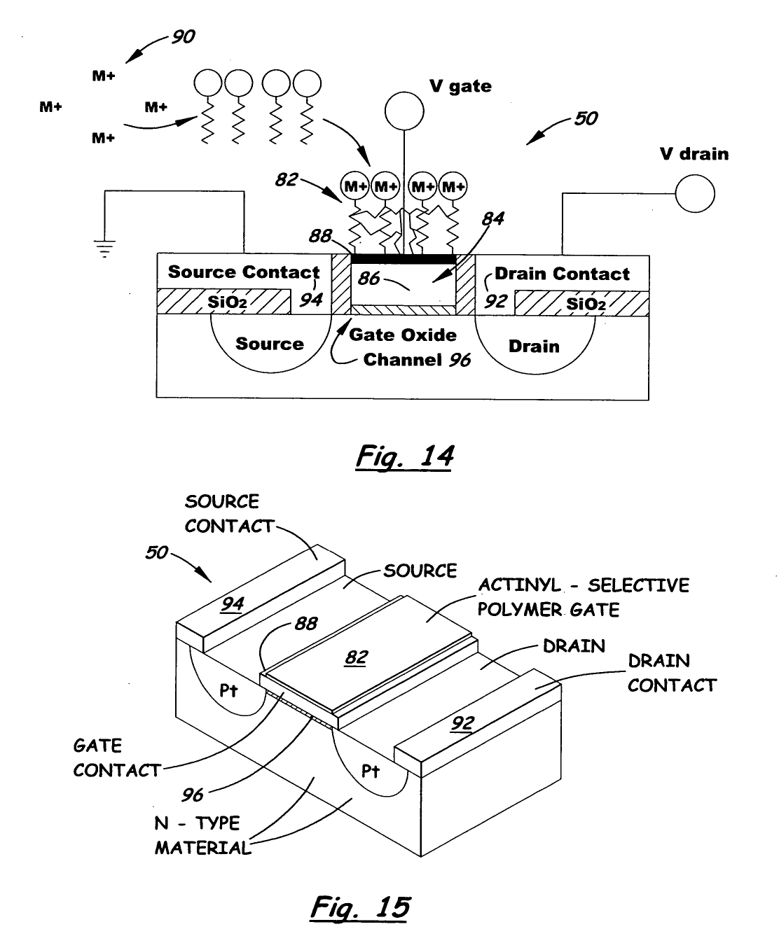

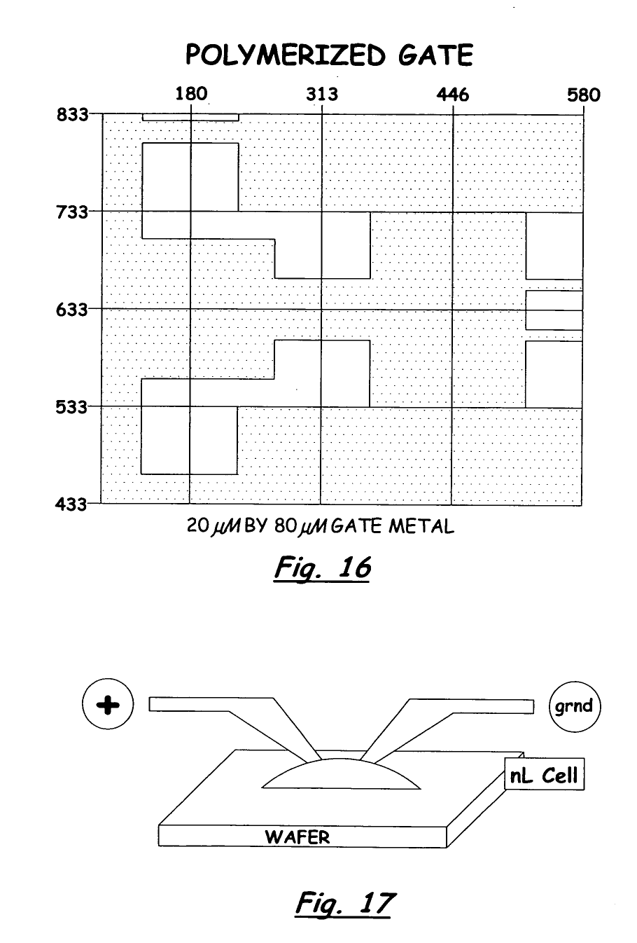

Alternatively, a sensing element according to the invention may utilize changes in surface potential of the surface comprising the chelating polymer. These changes may be detected as changes in source-drain current in a Field Effect Transistor (FET) comprising an actinyl-selective polymer. An embodiment of a Field-Effect Transistor (FET) 50, depicted in FIGS. 14-17, has been modified by electrodepositing an actinyl-selective polymer coating/layer 82 onto (over) the gate element, which layer may comprise a polymer 83 of the type shown in FIG. 2, for example, which would tend to become cross-linked during polymerization and deposition. Typically, a gate electrode 84 surface consists of a layer 86 of polycrystalline silicon material covered by a thin metal coating 88, such as Al, Mo, Ni, Ti, Ta, or others, whereas, in the FET sensor embodiment of the present invention, a layer 82 of actinyl-selective polymer is deposited/placed on the thin metal coating 88. When such a coated FET gate is placed in contact with an actinide solution, actinides 90 bind to its surface.

The pMOSFET represented by FIGS. 14-17 may be made by steps including: field oxidation (500 nm, RIT); scribe wafers, RCA clean; source/drain junction photolithography, wet etch field oxide, strip photoresist; RCA clean; source/drain spin on dopant and dopant diffusion (RIT); measure junction sheet resistance; gate oxide photolithography, wet etch oxide to prepare for gate oxide; strip photoresist; RCA clean; thin gate oxidation, 50 nm; contact photolithography, contact wet etch, strip photoresist; RCA clean; and selective deposition of actinyl-selective polymer in the gate region. Other FET devices may be adapted to comprise an actinyl-selective polymer, including nMOSFET. Alternatively, a nanoliter deposition method may be used.

The source-drain current of a FET sensing device 50, from drain contact 92 to source contact 94, will change according to the total amount of actinide ions bound to layer 82 on gate 84, because of the effect said actinide ions have on surface potential. Because the amount of actinide ions bound to the gate surface is a function of the concentration of actinide ions concentrations in the aqueous solution being tested, the source-drain current correlates with said concentration. In a typical sensing application, an AC bias voltage is applied across the source contact 94 and the drain contact 92 of a sensing FET.

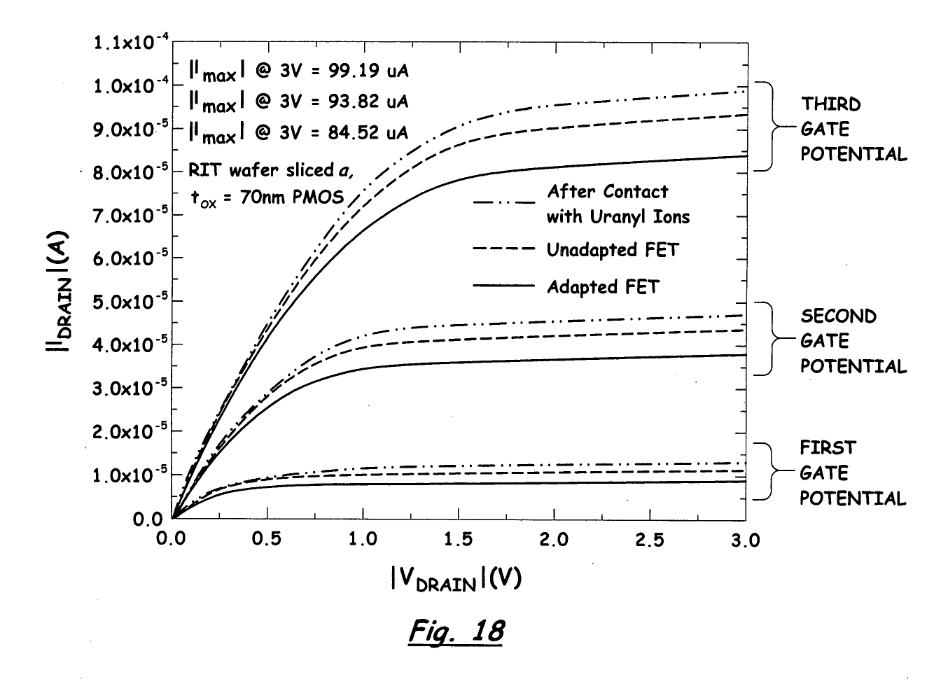

The current-to-voltage curves depicted in FIG. 18 (discussed later in more detail) are representative of the response (I_{drain} vs. V_{drain}) of a pMOSFET to which an AC bias voltage is applied. As the sweeping AC bias voltage becomes more positive, and when there is sufficient electrical potential at the gate (V_{g}>V_{threshold}), current flows in proportion to bias voltage level. The FET curves will exhibit a measurable shift in a sensing FET embodiment of the present invention, according to lesser or greater actinyl concentrations. In pure H₂O, there will be no current flow through a bias voltage sweep (i.e. a flat line). This is because, with no gate potential, there is no conduction path formed in the gate channel 96. In increasing concentrations of actinide ions in H₂O, the curve will be seen to grow in slope. This is because, as the gate potential increases beyond a threshold voltage Vₜ, substrate minority carriers (holes) are attracted to the semiconductor surface and a charge carrier channel (96) is formed where the semiconductor is actually changed from n-type to p-type. When potentials greater than Vₜ are present, channel width increases proportionally and greater currents can flow, since electron holes flow through p-type materials.

Multiple such FET devices may alternately be combined into sensing circuitry for purposes of sensing at multiple sampling ports, or for performing control measurements on pure H₂O or other pure solvents, when it is desired to comparatively sense the presence of actinide ions in test samples vs. control samples. Further, alternative monomer/polymer may be used for coating the gate surface, such as pyrrole, aniline, or other monomers that form semi-conducting films or even an insulating polymer such as PVC. In the case of the FET and the voltammetric electrode, polymers other than those specifically detailed in this Description may be used, with the preferred polymers being those that do not delaminate or swell.

The data in FIG. 18 illustrates that an FET device that is adapted to include an embodiment of the chelating polymer is responsive to the presence of uranium, and may be used as a sensor element. Three FET conditions were tested for each of the three gate potentials tested (resulting in three groups of curves, one near the bottom of the graph, one near the middle, and one near the top). First, an unadapted FET (prior to deposition of actinyl-selective polymer) was tested at each gate potential by measuring drain current vs. drain voltage (absolute values). Then, the adapted FET (comprising chelating polymer on gate surface, deposited by biasing the gate contact pad to coat the gate with the actinyl-selective polymer) was tested at each gate potential, without ever being in contact with uranium or other actinides. Thirdly, an adapted FET was soaked in a uranyl acetate solution (acetate being the counter-ion) for 1 hours, dried, and then tested.

One may see from FIG. 18 that the unadapted FET, the adapted FET, and the adapted FET having contacted uranium ions responded consistently at all three gate potentials, with the middle curves at all three gate potentials being the unadapted FET, the lowest curves at all three gate potentials being the adapted FET, and the highest curves at all three gate potentials being the adapted FET having contacted uranium.

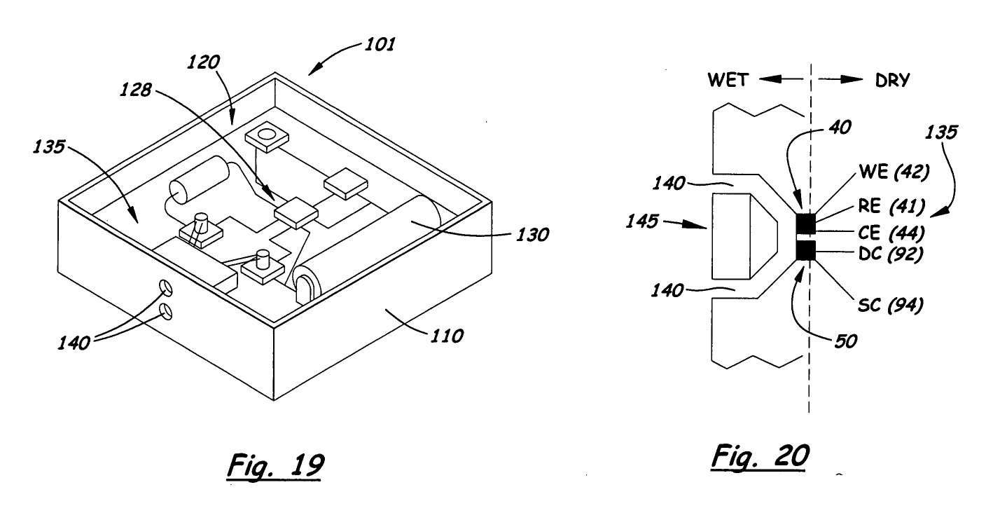

In the preferred embodiment, FET and voltammetric sensors, such as those described above, are combined into a single sensing assembly, as shown in FIGS. 19 and 20. The gate surface and the electrode surface of the FET and the voltammetric sensors, respectively, may feature the same actinyl-selective polymers, or different actinyl-selective polymers. For example, the polymers may have the same chelating molecules attached to the same polymer backbones, the same chelating molecules attached to different polymer backbones, different chelating molecules attached to the same polymer backbones, or different chelating molecules attached to different backbones. The comparison of the outputs from two types of sensors permits cross-verification and allow a mass balance calculation to be accomplished. Measurements taken from FET-based sensor 50 allow detection of total actinide ion concentration, while measurements taken from voltammetric sensor 40 can distinguish between any different actinides present in a sample and allow calculation of the concentration of each. These individual concentrations sum to a total ion concentration, as detected by the FET-based sensor 50. Thus, the comparison of these two sensor outputs provides an internal check of validity of sample results.

In FIG. 19, a detector probe 101 sealed, self-contained case 110 is depicted with top cover removed. It contains a circuit assembly 120 comprising control circuit 128 and power source 130. Also mounted on circuit assembly 120 are one or more voltammetric sensors 40 and one or more FET-based sensors 50, which may be mounted in a sensing subassembly 135, as depicted in FIG. 20. In this figure, ports 140 of port assembly 145 are shown connected to sensors 40 and 50 at their liquid interfacing surfaces. Electrical connections WE 42, RE 41, CE 44, drain contact DC 92 and source contact SC 94 are also shown extending from the dry side of the subassembly to be contacted by the liquid sample flow on the wet side.

FIGS. 19 and 20 illustrate ports 140, featuring but one of many possible port arrangements and one of many possible flow paths of sample liquid. Ports 140 are open to the outside of the case 110 and provide flow of sample liquid across the sensors 40, 50. The ports may be co-linearly located or they may be located upon opposite sides of case, for example. They may alternately be in communication with a remotely located sample liquid via extended tubing, for example. Flow past the sensor assembly may be provided by way of natural flow across the port openings in the case, or by way of a pump, for example. While case 110 is portrayed as generally box-shape, and while the probe cases/housings in FIGS. 7-9 are portrayed as elongated and pencil-shaped, many other shapes may be used. The elongated and/or pencil-shaped probe, with covers or windows, may be beneficial for probing to a particular depth after “breaking” through a top layer of debris or other matter, for example.

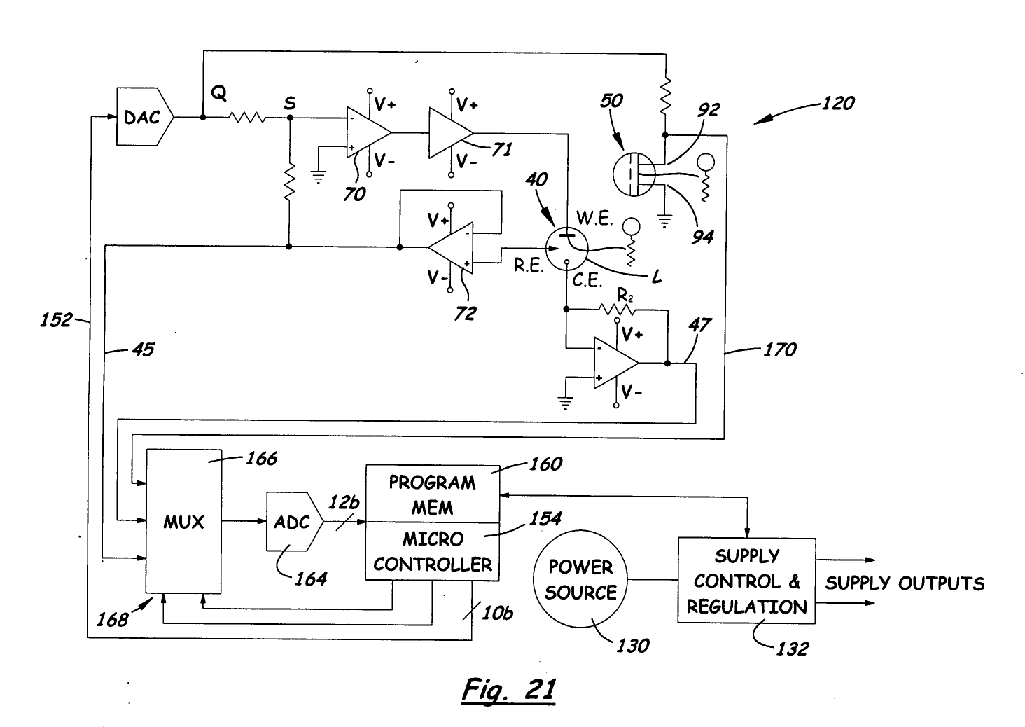

In FIG. 21, a schematic diagram of the combined sensing circuit assembly 120 is shown, which serves the combination of two different sensors 40 and 50. Sensors 40 and 50 are shown in FIG. 18, as is power source 130 and supply control and regulation section 132, which provides filtered and regulated DC voltages for supply of the various devices within the assembly. The function of the voltammetric section of the circuit is identical to the function of the circuit described above, in reference to the circuit of FIG. 10. The excitation voltage at summing node S in this circuit is provided by the output of Digital-to-Analog Converter (DAC) 150, which is driven, in-turn, by the data lines 152 that are output from microcontroller 154. Microcontroller 154 is operated by way of embedded programs that may be loaded and stored in program memory 160.

In operating this circuit, microcontroller 154 obtains input voltage levels that are detected by Analog to Digital Converter (ADC) 164. ADC 164, in-turn, accepts voltage levels from the output of analog multiplexer (MUX) 166, which is controlled, in-turn, by MUX select lines 168 from microcontroller 154. MUX 166 accepts input voltage signals from three sources; current-axis output signal 47, potential-axis output signal 45, and FET current sense output DC 170. DAC 150, under program control of microcontroller 154 and DAC control lines 152, outputs AC bias voltages to output node Q and summing node S, in order to excite sensors 40 and 50 so that they may be measured. In typical operation, the DAC 150 voltage output is varied, while the input lines to MUX 166 are selectively measured as the program in memory 160 is executed by microcontroller 154.

An algorithm that steps through different DAC levels and takes a series of measurements of the three input sources can be implemented to provide results that can be subsequently stored for later retrieval in the RAM of microcontroller 154. Data comparisons between stored reference values and sampled values can yield information about actinide concentrations. Again, the comparison of the outputs from sensors 40 and 50 permit cross-verification, allow for mass balance calculations, detection of total actinide ion concentrations, and detection of concentrations of specific different actinides present. Interface means to microcontroller 154 are commonly known in the art and may be implemented upon this preferred embodiment so as to facilitate data exchange to host computing devices and/or databases.

Other numbers of sensor elements, other types of sensor elements, and other electronics, may be incorporated into the probe and detection system while still retaining the small size, simple and easily-portable operation. Data buffer and/or data transmission circuitry and connections may be included and will be understood by one of skill in the art after viewing this Description and the Drawings.

### WORKED EXAMPLE

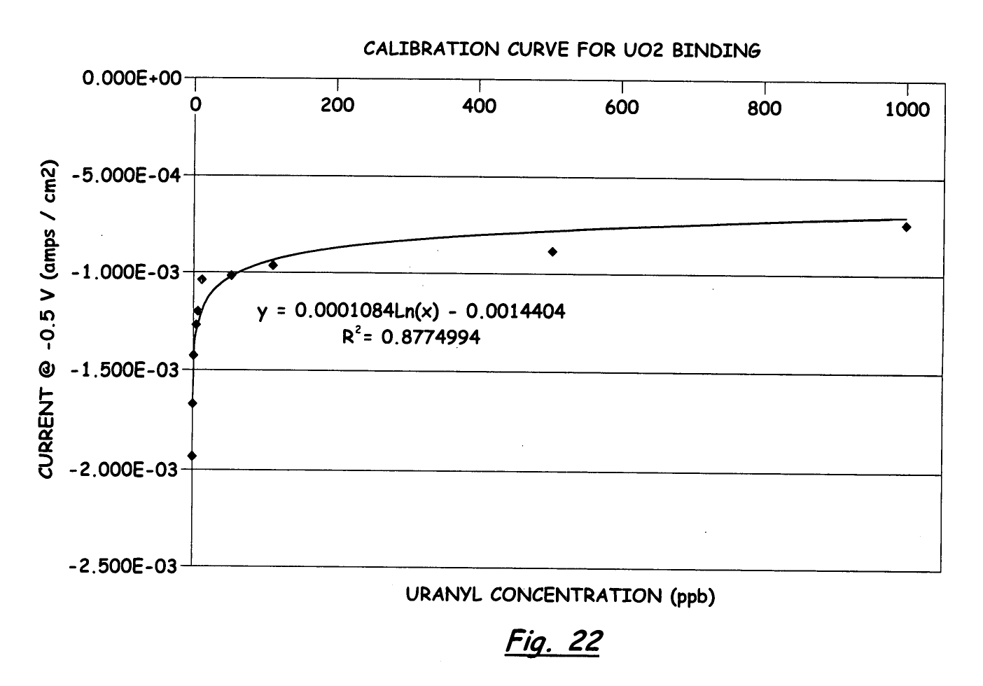

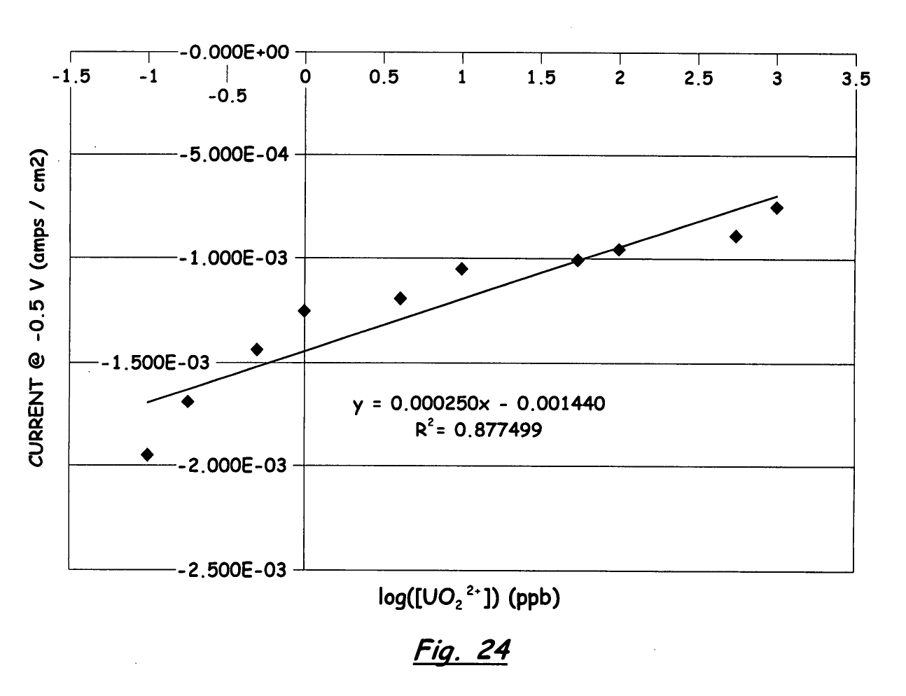

FIGS. 22-26 illustrate data from an electrode made according to an embodiment of the invention that was tested in aqueous solutions containing a wide range of UO₂²⁺ concentrations, in aqueous solutions containing a range of ThO₂⁺, and in an aqueous solution containing both uranium and thorium. The electrode used for these tests was made according to the synthesis of FIGS. 3-6.

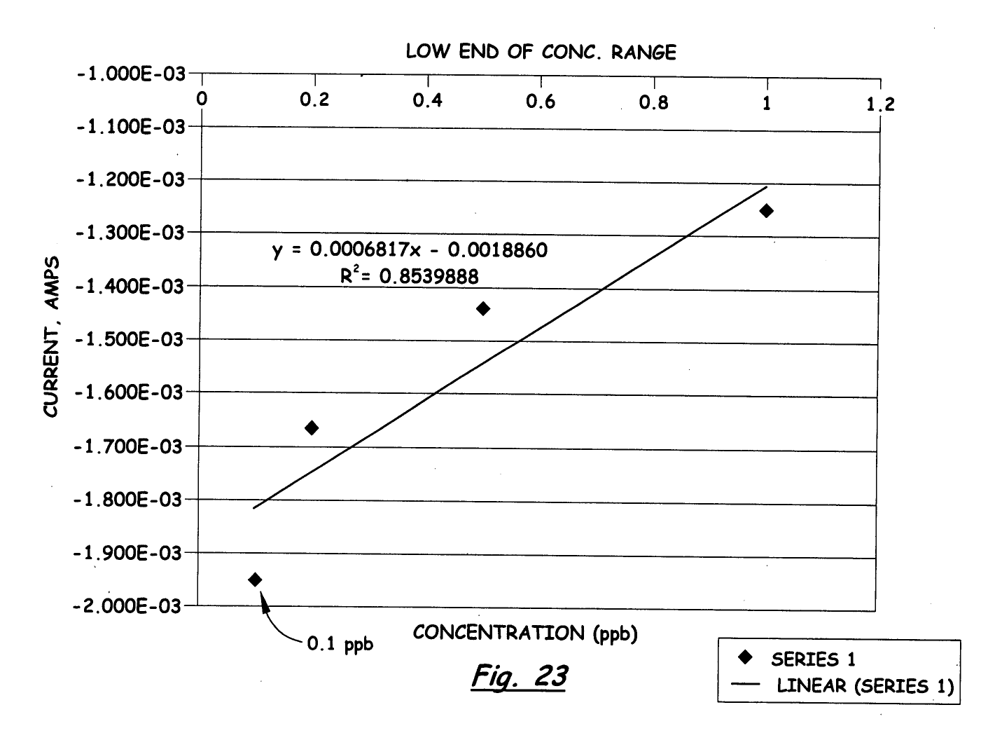

The data from FIGS. 22-24 was obtained from uranium ion solutions containing 0.1 M KNO₃, as an inert electrolyte, with UO₂²⁺ (NO₃)₂ concentrations ranging from 0.1 ppb up to 1000 ppm. I vs. E curves (current vs. voltage) curves resulting from voltage sweep were obtained, and the data at −0.5 volts was plotted, yielding the adsorption isotherm of FIG. 22. The data at the low concentrations is plotted in FIG. 23, and the data over the entire range is plotted as current vs. Log[UO₂²⁺ concentration, ppb]. The data confirms excellent sensitivity to concentration of the UO₂²⁺ ion in aqueous solution. From this and other data, the inventors expect that field-portable embodiments of the invention will be capable of detecting down to approximately 10 parts per trillion.

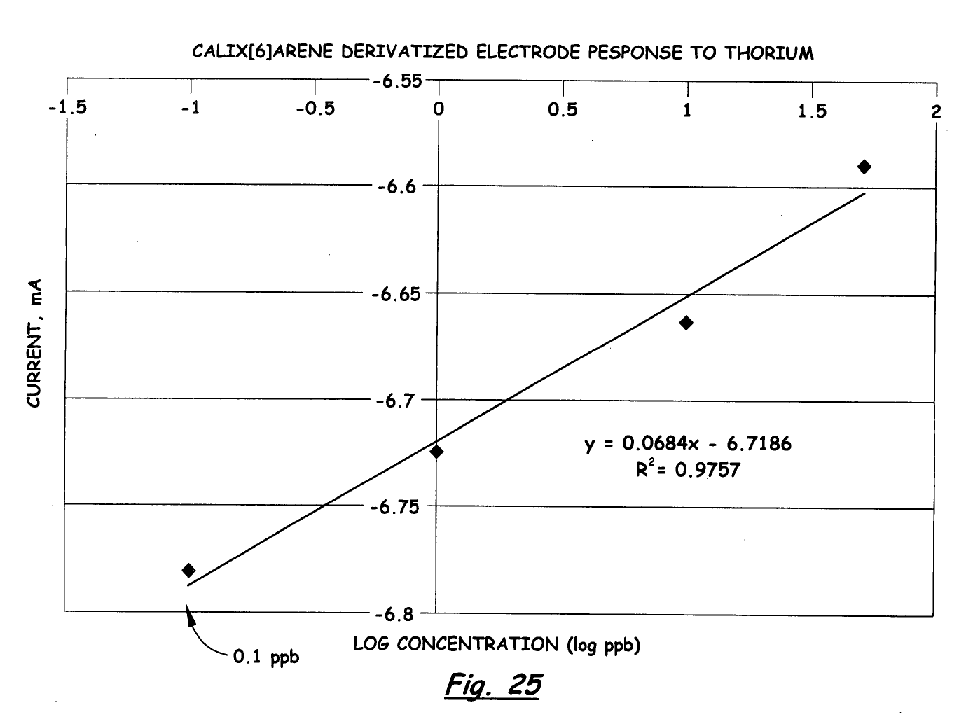

The data from FIG. 25 was obtained from thorium ion solutions containing 0.1 ppb up to approximately 100 ppb thorium ion. The data confirms excellent sensitivity to concentration of ThO₂⁺ ion in aqueous solution.

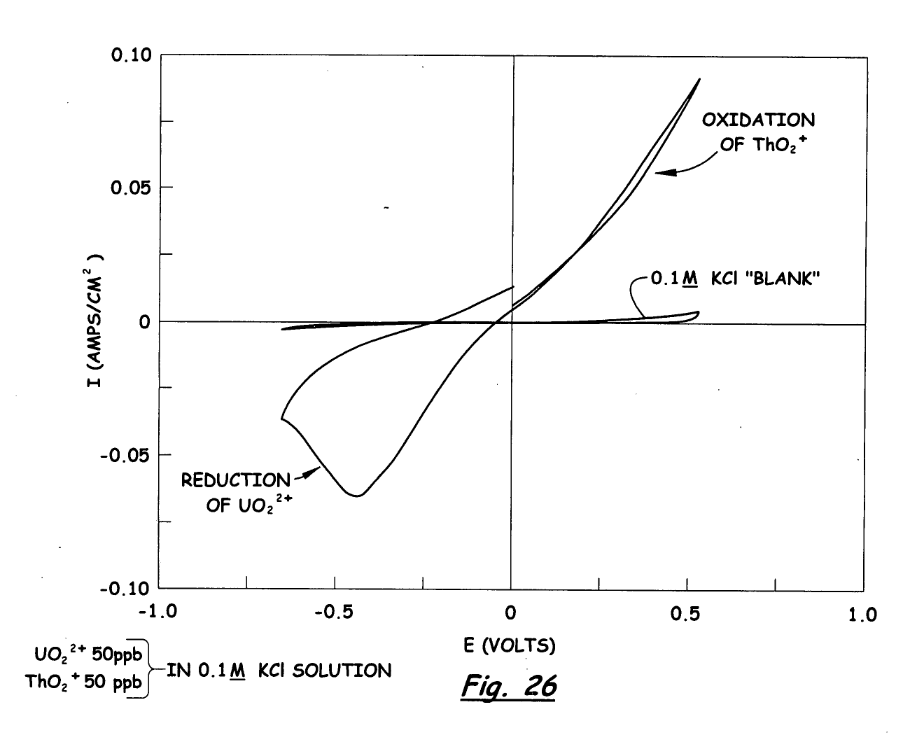

The data from FIG. 26 was obtained from a uranium and thorium mixture solution containing 50 ppb UO₂²⁺ and 50 ppb ThO₂⁺ in 0.1 M KCl solution, vs. a blank. The inventors believe the data from approximately 0 to −0.7 volts to be the electrode response to the uranium ions, and the date from approximately 0 to 0.5 volts to be the electrode response to the thorium ions, again confirming the ability of electrodes according to embodiments of the invention to detect multiple different ions in the same aqueous solution at generally the same time.

One may see that embodiments of the invention may be used to detect actinide ions in aqueous solution, by measuring the resulting current at one or more selected drive voltages and correlating the current data to actinide ion concentration. As discussed above, detection also may be done with a voltammetric system, wherein voltage is applied, and the conductive chelating polymer allows current flow, said current flow being a function of the electron transfer reactions at the chelated actinide ions, and, therefore, a function of the number of actinide ions chelated to the polymer, and therefore a function of the actinide ion concentration in solution. Also, as discussed above, said measuring and correlating may be done with an FET system, wherein current flow in response to an applied voltage is a function of the surface potential of the chelating-polymer-coated gate, and, therefore a function of the number of chelated actinide ions, and therefore a function of the actinide ion concentration in solution. By using both a voltammetric sensor and an FET sensor, embodiments of the invention may measure total actinide concentration and the concentration of individual actinide species, and may crosscheck the accuracy of the individual sensors.

The preferred polymer with the chelating molecules is highly selective for actinides over other metal ions, greatly reducing the probability of false-positive readings. Actinide ions are trapped by the chelating molecules, which alters the electrical potential and/or conducting properties of a sensing electrode/FET. Sensors may be designed to detect the total concentration of actinide ions and/or the individual concentrations of any specific ions in the actinide genus. In the preferred embodiment, multiple sensing elements, adapted for use simultaneously or sequentially, comprising at least one voltammetric electrode sensor and at least one adapted FET sensor, are used in order to measure a) total actinide concentration, b) the concentration of individual actinide species, and c) to crosscheck the accuracy of individual sensors.

It should be understood that embodiments of the invention may include apparatus, including polymers, sensors, probes, circuitry, and/or systems including said polymers, sensors, probes, circuitry, and may also include methods of making and/or using said apparatus. Also, although this invention has been described above with reference to certain particular means, materials, and embodiments, it is to be understood that the invention is not limited to these disclosed particulars, but extends instead to all equivalents within the broad scope of the following claims.

What we claim is:

1. A sensor for uranium and other actinides, comprising:
an actinyl-selective polymer containing chelating molecules selective for actinyl ions;
said actinyl-selective polymer being combined with a sensor element which is adapted to detect changes in the electrical potential or conducting properties of the polymer in the presence of actinyl ions.

2. The sensor of claim 1 wherein the polymer contains chelating molecules selective to ions having the general formula MO₂^{X}, where M represents a metal in the actinide group and X represents a charge of +1 or +2.

3. The sensor of claim 2 wherein the polymer contains chelating molecules selective to ions selected from the group consisting of: UO₂²⁺, PuO₂²⁺, PuO₂¹⁺, and ThO₂¹⁺.

4. The sensor of claim 1 wherein the polymer is made by first polymerizing a monomer and then derivatizing the polymer with a calix[n]arene ring (where n=4-10) compound.

5. The sensor of claim 1 wherein said chelating molecules comprise a calix[n]arene ring (where n=4-10) compound.

6. The sensor of claim 1 wherein said chelating molecules comprise a calix[6]arene ring compound.

7. The sensor of claim 1 wherein the sensor element comprises a Metal Oxide Semi-Conductor Field-Effect Transistor (MOSFET).

8. The sensor of claim 1 which comprises multiple sensing elements wherein there is at least one voltametric electrode sensor element and at least one MOSFET sensor element.

9. A method of sensing uranium and other actinides, the method comprising:
providing an actinyl-selective polymer containing chelating molecules selective for actinyl ions;
exposing said polymer to a liquid containing actinyl ions; and
detecting changes in electrical potential or conducting properties of said polymer in the presence of said actinyl ions.

10. The method of claim 9 wherein the polymer contains chelating molecules selective to ions having the general formula MO₂^{x}, where M represents a metal in the actinide group and X represents a charge of +1 or +2.

11. The method of claim 10 wherein the polymer contains chelating molecules selective to ions selected from the group consisting of: UO₂²⁺, PuO₂²⁺, PuO₂¹⁺, and ThO₂¹⁺,

12. The method of claim 9 wherein the polymer is made by first polymerizing a monomer and then derivatizing the polymer with a calix[n]arene ring (where n=4-10) compound.

13. The method of claim 9 wherein said chelating molecules comprise a calix[n]arene ring (where n=4-10) compound.

14. The sensor of claim 9 wherein said chelating molecules comprise a calix[6]arene ring compound.

15. The method of claim 9 wherein said actinyl-selective polymer is operatively connected to a sensor element comprising a Metal Oxide Semi-Conductor Field-Effect Transistor (MOSFET) and said MOSFET performs said detecting of changes in electrical potential or conducting properties of said polymer.

16. The method of claim 9 wherein said actinyl-selective polymer is operatively connected to multiple sensing elements wherein there is at least one voltametric electrode sensor element and at least one MOSFET sensor element.

17. The method of claim 16, further comprising using said multiple sensing elements to measure total actinide concentration, to measure concentration of individual actinide species, and to crosscheck accuracy of individual ones of said multiple sensing elements.
